(19) United States
(12) Patent Application Publication
(10) Pub. No.: US 2013/0166714 A1
(43) Pub. Date: Jun. 27, 2013

(54) SYSTEM AND METHOD FOR DATA STORAGE

(71) Applicant: ZHONG-LIN XU, Shenzhen City (CN)

(72) Inventor: ZHONG-LIN XU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/434,869

(22) Filed: Mar. 30, 2012

(30) Foreign Application Priority Data
Dec. 26, 2011 (CN) 201110440375.6

(51) Int. Cl. G06F 15/173

(52) U.S. Cl. 709/223

(57) ABSTRACT

A storage system includes a plurality of storage servers connected in a hierarchical fashion to form a tree structured network accessible by a client computer via a network. The storage servers includes a root node storage server at a highest level in the hierarchy, a plurality of second level node storage severs at a second level connected to the root node storage server, and a plurality of third level node storage severs at a third level connected to the corresponding second level node storage servers. The root node storage server receives and stores data from the client computer. Each of the second level node storage severs obtains the data from the root node storage server and stores the data thereon. Each of the third level node storage severs obtains the data from the corresponding second node storage server and stores the data thereon. A related method is also provided.

### BACKGROUND

1. Technical Field

The present disclosure relates to a data storage system and a data storage method.

2. Description of the Related Art

Data of a network server are stored on a main data storage. In case the data stored on the main data storage should become lost or corrupted, an auxiliary data storage is often employed as a backup. However, data in the main data storage may seldom if ever actually become lost or corrupted meaning the auxiliary data storage remains idle. Further, to transfer backup data stored on the auxiliary data storage to the main data storage requires an additional disk. Thus, the auxiliary machine and the additional disk can needlessly increase the cost for data backup of the server.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of a data storage system including a plurality of storage servers in accordance with an exemplary embodiment.

FIG. 2 is a flowchart illustrating a method for data storage applied in the data storage system of FIG. 1 in accordance with an exemplary embodiment.

### DETAILED DESCRIPTION

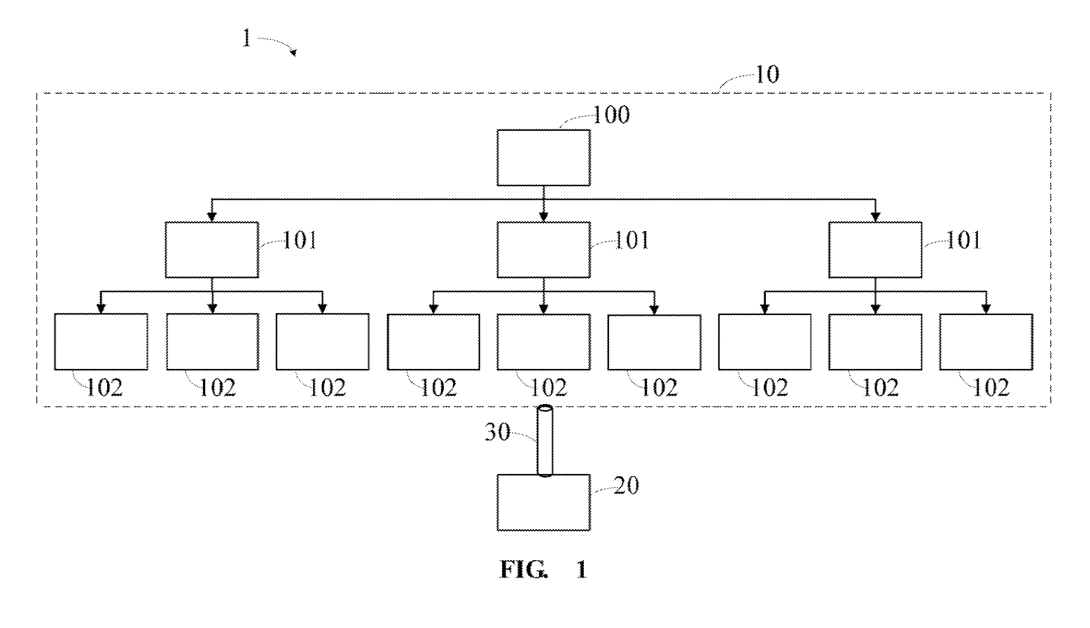

Referring to FIG. 1, a storage system 1 includes a plurality of storage servers 10 capable of being accessed by a client computer 20 via a network 30. In the embodiment, the pluralities of storage servers 10 are connected in a hierarchical fashion to form a tree structured network. Each of the plurality of storage servers 10 includes a root node storage 100 at a highest level in the hierarchy, a plurality of second level node storage servers 101 at a second level connected to the root node storage server 100, and a plurality of third level node storage servers 102 at a third level connected to the corresponding second level node storage servers 101. The root node storage server 100 is configured for receiving and storing data from the client computer 20 thereon.

In the second level, each of the plurality of second level node storage servers 101 is configured for obtaining the data from the root node storage server 100 automatically triggered by the root node storage server 100 upon completion of storing the data on the root node storage server 100, and further configured for storing the data thereon. Thus, the data stored on the root node storage server 100 is backed up in the second level node storage servers 101.

In the third level, each of the plurality of third level node storage server 102 is configured for obtaining the data from the corresponding second level node storage server 101 automatically triggered by the corresponding second level node storage server 101 upon completion of storing the data on the corresponding second level node storage server 101, and further configured for storing the data thereon. Thus, the data stored on each second level node storage server 101 is backed up in the third level node storage server 102.

When the data stored on the root node storage server 100 is updated, such as newly written or deleted, the data stored on each second level node storage server 101 and each third level node storage server 102 are is updated correspondingly. If the root node storage servers 100 is destroyed, the data stored on the second level storage servers 101 is accessible by the client computer 20. If the one of the second level node storage servers 101 is destroyed, the data stored on the third level storage servers 102 which is connected to the destroyed second level node storage server 101 is accessible by the client computer 20.

If the data stored on the root node storage server 100 is lost or destroyed, the data stored on the second level node storage servers 101 can be uploaded onto the root node storage server 100 to recover the data. If the data stored on one of the second level node storage servers 101 is lost or destroyed, the data stored on the third level node storage servers 102 which are connected to the second level node storage server 101 can be uploaded onto the second level node storage server 101.

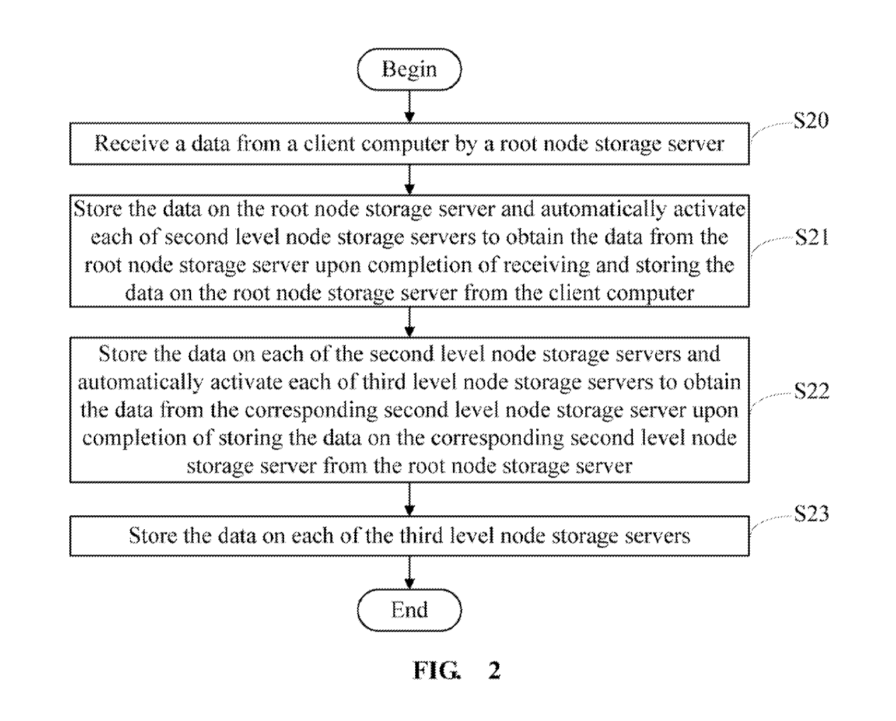

FIG. 2 is a flowchart illustrating a data storage method.

In step S20, the root node storage server 100 receives the data from the client computer 20.

In step S21, the root node storage server 100 stores the data and automatically triggers each of the second level node storage servers 101 to obtain the data from the root node storage server 100 upon completion of storing the data on the root node storage server 100.

In step S22, each of the second level node storage servers 101 stores the data and automatically triggers each of the third level node storage servers 102 to obtain the data from the corresponding second level node storage server 101 upon completion of storing the data on the corresponding second level node storage server 101.

In step S23, each of the third level node storage servers 102 stores the data thereon.

When the data stored on the root node storage server 100 is updated, such as newly written or deleted, the data stored on each second level node storage server 101 and each third level node storage server 102 are is updated correspondingly. If the root node storage servers 100 is destroyed, the data stored on the second level storage servers 101 is accessible by the client computer 20. If the one of the second level node storage servers 101 is destroyed, the data stored on the third level storage servers 102 which is connected to the destroyed second level node storage server 101 is accessible by the client computer 20.

If the data stored on the root node storage server 100 is lost or destroyed, the data stored on the second level node storage servers 101 can be uploaded onto the root node storage server 100 to recover the data. If the data stored on one of the second level node storage servers 101 is lost or destroyed, the data stored on the third level node storage servers 102 which are connected to the second level node storage server 101 can be uploaded onto the second level node storage server 101.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A storage system comprising:
a plurality of storage servers connected in a hierarchical fashion to form a tree structured network accessible by a client computer via a network, the storage servers comprising a root node storage server at a highest level in the hierarchy, a plurality of second level node storage severs at a second level connected to the root node storage server; and a plurality of third level node storage severs at a third level connected to the corresponding second level node storage servers; wherein the root node storage server is configured for receiving and storing the data from the client computer thereon, each of the second level node storage severs is configured for obtaining the data from the root node storage server and storing the data thereon; and each of the third level node storage severs is configured for obtaining the data from the corresponding second node storage server and storing the data thereon.

2. The storage system as recited in claim 1, wherein the root node storage server is configured for automatically activating each of the second level node storage severs to obtain and store the data upon completion of receiving and storing the data from the client computer, and each of the second level node storage severs is configured for automatically activating each of the third level node storage severs to obtain and store the data upon completion of obtaining and storing the data on said second level node storage sever.

3. A data storage method comprising:
receiving a data from a client computer using a tree structured network, the tree structured network comprising a plurality of storage servers connected in a hierarchical fashion, the storage servers comprising a root node storage server at a highest level in the hierarchy, a plurality of second level node storage severs at a second level connected to the root node storage server, and a plurality of third level node storage severs at a third level connected to the corresponding second level node storage servers;
storing the data on the root node storage server and automatically triggering each of the second level node storage severs to obtain the data from the root node storage server upon completion of storing the data on the root node storage server;
storing the data on each of the second level node storage severs and automatically triggering each of the third level node storage severs to obtain the data from the corresponding second level node storage server upon completion of storing the data on the corresponding second level node storage server; and
storing the data on each of the third level node storage severs.

4. The method as recited in claim 3, wherein if one of the storage servers is destroyed, the data stored on the storage servers at a lower level is accessible by the client computer.

5. The method as recited in claim 3, wherein if the data stored on one of the storage server is destroyed, the data stored on the storage server at a lower level is uploaded onto said one of the node storage sever to recover the data.
